(19) United States
(12) Patent Application Publication
(10) Pub. No.: US 2025/0362245 A1
(43) Pub. Date: Nov. 27, 2025

(54) PROTECTIVE ARMOR FOR BENDABLE DIGITAL DETECTOR

(71) Applicant: Abhinav Singh, NEW CASTLE, WA (US)

(72) Inventors: Abhinav Singh, NEW CASTLE, WA (US); Christian Fabian Martinez, MILL CREEK, WA (US)

(21) Appl. No.: 19/215,388

(22) Filed: May 22, 2025

Related U.S. Application Data
(60) Provisional application No. 63/650,577, filed on May 22, 2024.

(51) Int. Cl. G01N 23/04; G01D 11/24

(52) U.S. Cl. CPC G01N 23/04; G01D 11/245; G01N 2223/1016; G01N 2223/301; G01N 2223/50

(57) ABSTRACT

Disclosed is an armor for bendable digital detectors. The armor includes a body having first and second portions, and one or more chain link assembly coupled to the first and second portions. Each chain link assembly includes at least two chain links coupled to each other, with each chain link having a head end and a tail end. The chain links include one or more semicircular parts at the head end and a semicircular part at the tail end. The semicircular parts have projections, including a first projection slanting away from the respective end and a second projection at a right angle to the longitudinal axis of the chain link assembly. The semicircular parts are configured to engage with adjacent chain links, enabling controlled movement and flexibility of the armor while protecting the bendable digital detector.

### CROSS-REFERENCE TO RELATED APPLICATIONS

The present application claims priority to U.S. Provisional Patent Application Ser. No. 63/650,577, filed May 22, 2024, titled “PROTECTIVE ARMOR FOR BENDABLE DIGITAL DETECTOR,” the entireties of which is hereby incorporated by reference.

### TECHNICAL FIELD

The present disclosure relates to armor and more particularly the present disclosure relates to the protective armor for bendable digital detectors.

### BACKGROUND

In the industrial sector, digital detectors, commonly referred to as DR or flat panels, are frequently used. Traditional digital detectors are rigid and inflexible, posing challenges when mounting on curved surfaces such as oil and gas pipes. To address this, significant research and development have focused on creating flexible detectors. However, these flexible detectors are prone to damage due to various factors, including: —Excessive bending from external forces during handling. —High temperatures encountered in field operations. —Impact damage from drops, shocks, or falls due to improper mounting. —Damage from excessive stretching or bending of the cables connecting the detector to control units or laptops. —Damage from bending the detector in the opposite direction of intended use.

To mitigate these issues, an advanced protective armor or case is essential for safeguarding flexible detectors. This armor not only protects but also incorporates features like lead sleeves to reduce backscatter during high radiation usage, a heat dissipation mechanism during use at high temperature and a pull string or wire mechanism to maneuver the detector behind walls or other obstructions during field use.

### SUMMARY

In an embodiment of the present disclosure, an armor for bendable digital detectors is disclosed. The armor includes a body having first and second portions. The armor also includes one or more chain link assembly coupled to the first and second portions. Each of the one or more chain link assembly comprises at least two chain links coupled to each other. Each chain link has a head end and a tail end. Each chain link includes one or more semicircular parts disposed at the head end. Each semicircular part of the one or more semicircular parts comprises first and second projections projecting from first and second ends, respectively. The first projection slants at an angle in a direction away from the head end. The second projection is at a right angle with respect to a longitudinal axis of the one or more chain link assembly. Each chain link also includes a semicircular part disposed at the tail end. The semicircular part is configured to be engaged with the one or more semicircular parts of the head end of an adjacent chain link. The semicircular part disposed at the tail end comprises first and second projections projecting from first and second ends, respectively. The first projection slants at an angle in a direction away from the tail end. The second projection is at a right angle with respect to the longitudinal axis of the one or more chain link assembly.

In some embodiments of the present disclosure, the first portion comprises first and second blind slots disposed at first and second side ends. The second portion comprises first and second through slots disposed at first and second side ends.

In some embodiments of the present disclosure, the body further comprises a third portion disposed between the first and second portions. The third portion is coupled to the first and second portions at first and second ends of the third portion, respectively.

In some embodiments of the present disclosure, the third portion is flexible and composed of one of rubber, polyurethane, polycarbonate, polyether, polyester, or a combination thereof.

In some embodiments of the present disclosure, each semicircular part of the one or more semicircular parts disposed at the head end and the semicircular part disposed at the tail end have through holes.

In some embodiments of the present disclosure, each semicircular part of the one or more semicircular parts disposed at the head end is configured to be engaged with the semicircular parts of the tail end of the adjacent chain link by way of at least one pin.

In some embodiments of the present disclosure, one or more chain link assembly further comprise one or more first connector components coupled to a first link of the at least two chain links. Each of the one or more first connector components comprise a semicircular part disposed at a first end that is configured to be coupled to the one or more semicircular parts disposed at the head end of the first link. The one or more chain link assembly also comprise one or more second connector components coupled to a last link of the at least two chain links. Each of the one or more second connector components comprise one or more semicircular parts at a first end that is configured to be coupled to the semicircular part disposed at the tail end of the last link.

In some embodiments of the present disclosure, the one or more first connector components are further coupled to the first portion by way of one or more blind slots disposed at one or more side ends of the first portion, respectively.

In some embodiments of the present disclosure, each of the one or more second connector components further include a through slot disposed at a second end and a spring disposed in the through slot.

In some embodiments of the present disclosure, the one or more second connector components are further coupled to the second portion by way of one or more through slots disposed at one or more side ends of the second portion, respectively. The through slot disposed at the second end of each of the one or more second connector components and the spring is disposed inside each of the one or more through slots, respectively.

In some embodiments of the present disclosure, to couple the one or more second connector components to the second portion, at least one pin is configured to pass through each of the one or more through slots and the through slot disposed at the second end of each of the one or more second connector components such that a first end of the spring is disposed on the inner circumferential region of the through slot and a second end of the spring is disposed on the at least one pin.

In some embodiments of the present disclosure, the armor further comprises a lead shielding sheet disposed on a rear face of the body. The lead shielding sheet is configured to absorb backscattered radiation.

In some embodiments of the present disclosure, the armor further comprises one or more shackles coupled to the second portion and at least one shackle coupled to the first portion.

In some embodiments of the present disclosure, the armor further comprises at least one aperture disposed on the first portion. The at least one aperture is configured to receive at least cable connector pin of at least one connecting wire.

In another embodiment of the present disclosure, a system is disclosed. The system comprises a bendable digital detector and an armor configured to receive the bendable digital detector. The armor comprises a body having first and second portions and one or more chain link assembly coupled to the first and second portions. Each of the one or more chain link assembly comprises at least two chain links coupled to each other. Each chain link of the at least two chain links have a head end and a tail end. Each chain link of the at least two chain links includes one or more semicircular parts disposed at the head end. Each semicircular part of the one or more semicircular parts comprises first and second projections projecting from first and second ends, respectively. The first projection slants at an angle in a direction away from the head end. The second projection is at a right angle with respect to a longitudinal axis of the one or more chain link assembly. Each chain link also comprises a semicircular part disposed at the tail end. The semicircular part is configured to be engaged with the one or more semicircular parts of the head end of an adjacent chain link. The semicircular part disposed at the tail end comprises first and second projections projecting from first and second ends, respectively. The first projection slants at an angle in a direction away from the tail end. The second projection is at a right angle with respect to the longitudinal axis of the one or more chain link assembly.

In some embodiments of the present disclosure, the system further comprises a control box that is coupled to the bendable digital detector and configured to receive one or more X-ray images from the bendable digital detector.

In some embodiments of the present disclosure, the first portion comprises first and second blind slots disposed at first and second side ends. The second portion comprises first and second through slots disposed at first and second side ends.

In some embodiments of the present disclosure, the body further comprises a third portion disposed between the first and second portions. The third portion is coupled to the first and second portions at first and second ends of the third portion, respectively.

In some embodiments of the present disclosure, the third portion is flexible and composed of one of rubber, polyurethane, polycarbonate, polyether, polyester, or a combination thereof.

In some embodiments of the present disclosure, each semicircular part of the one or more semicircular parts disposed at the head end and the semicircular part disposed at the tail end have through holes.

In some embodiments of the present disclosure, each semicircular part of the one or more semicircular parts disposed at the head end is configured to be engaged with the semicircular parts of the tail end of the adjacent chain link by way of at least one pin.

In some embodiments of the present disclosure, one or more chain link assembly further comprise one or more first connector components coupled to a first link of the at least two chain links. Each of the one or more first connector components comprise a semicircular part disposed at a first end that is configured to be coupled to the one or more semicircular parts disposed at the head end of the first link. The one or more chain link assembly also comprise one or more second connector components coupled to a last link of the at least two chain links. Each of the one or more second connector components comprise one or more semicircular parts at a first end that is configured to be coupled to the semicircular part disposed at the tail end of the last link.

In some embodiments of the present disclosure, the one or more first connector components are further coupled to the first portion by way of one or more blind slots disposed at one or more side ends of the first portion, respectively.

In some embodiments of the present disclosure, each of the one or more second connector components further include a through slot disposed at a second end and a spring disposed in the through slot.

In some embodiments of the present disclosure, the one or more second connector components are further coupled to the second portion by way of one or more through slots disposed at one or more side ends of the second portion, respectively. The through slot disposed at the second end of each of the one or more second connector components and the spring is disposed inside each of the one or more through slots, respectively.

In some embodiments of the present disclosure, to couple the one or more second connector components to the second portion, at least one pin is configured to pass through each of the one or more through slots and the through slot disposed at the second end of each of the one or more second connector components such that a first end of the spring is disposed on the inner circumferential region of the through slot and a second end of the spring is disposed on the at least one pin.

In some embodiments of the present disclosure, the armor further comprises a lead shielding sheet disposed on a rear face of the body. The lead shielding sheet is configured to absorb backscattered radiation.

In some embodiments of the present disclosure, the armor further comprises one or more shackles coupled to the second portion and at least one shackle coupled to the first portion.

In some embodiments of the present disclosure, the armor further comprises at least one aperture disposed on the first portion. The at least one aperture is configured to receive at least cable connector pin of at least one connecting wire that is configured to couple the bendable digital detector to the control box.

The foregoing general description of the illustrative embodiments and the following detailed description thereof are merely exemplary aspects of the teachings of this disclosure and are not restrictive.

### BRIEF DESCRIPTION OF THE DRAWINGS

The above and still further features and advantages of embodiments of the present invention becomes apparent upon consideration of the following detailed description of embodiments thereof, especially when taken in conjunction with the accompanying drawings, and wherein:

FIG. 1 illustrate a system for detection of defects in a pipe, according to embodiments of the present disclosure.

FIG. 2A illustrates an isometric view of an armor housing a bendable digital detector in FIG. 1, according to an exemplary embodiment of the present disclosure.

FIG. 2B illustrates an exploded view of top face of the isometric view of the FIG. 2A, according to an exemplary embodiment of the present disclosure.

FIG. 2C illustrates an isometric exploded view of a rear face of the armor of the FIG. 2A, according to an exemplary embodiment of the present disclosure.

FIG. 3 illustrates an isometric view of a third portion of the armor of FIG. 2A, according to an exemplary embodiment of the present disclosure.

FIG. 4 illustrates an isometric view of a second portion of the armor of FIG. 2A, according to an exemplary embodiment of the present disclosure.

FIG. 5 illustrates a chain link of a chain portion of FIG. 2B, according to an exemplary embodiment of the present disclosure.

FIG. 6 illustrates coupling of the one or more chain links within the one or more chain link assembly in an unbent position, according to an exemplary embodiment of the present disclosure.

FIG. 7 illustrates a side view of a second connector component of one or more second connector components of the one or more chain link assembly, according to an exemplary embodiment of the present disclosure.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

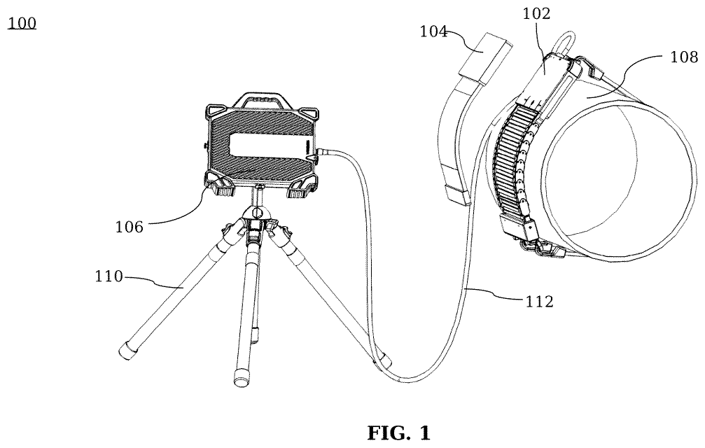

The present disclosure relates to an armor for bendable digital detectors and a system for detecting defects in a pipe by way of the digital detectors received within the armor. FIG. 1 illustrates a system 100 for detection of defects in pipes, according to embodiments of the present disclosure. As illustrated in FIG. 1, the system 100 may include an armor 102, a bendable digital detector 104, a control box 106, a pipe 108, a stand 110, and at least one connecting wire 112.

The armor 102 may be configured to receive the bendable digital detector 104. The armor 102 may be configured to provide an enclosure for the bendable digital detector 104 to protect the bendable digital detector 104 from external impacts. Further, the armor 102 may be configured to enable controlled bending movement of the bendable digital detector 104 such that beyond a predefined degree of bend, bending of the bendable digital detector 104 is locked. The armor 102 may further be configured to allow a controlled bending movement of the bendable digital detector 104 in one side while restricting the movement of the bendable digital detector 104 in other side. In other words, the armor 102 may be configured to restrict the bendable digital detector 104 to bent in a direction that is opposite to intended use of the bendable digital detector 104.

In some aspects of the present disclosure, the armor 102 may be rated IP67 or above. The armor 102 may be made of water-resistant material. For example, the water-resistant material may include, but is not limited to, polyurethane, PVC waterproofing membrane, silicone, thermoplastic, EPDM rubber, or a combination thereof. Embodiments of the present disclosure are intended to include and/or otherwise cover any type of known and later developed water-resistant materials, without deviating from the scope of the present disclosure.

The bendable digital detector 104 may be housed inside the armor 102 and configured to detect defects in the pipe 108. The bendable digital detector 104 housed inside the armor 102 may be configured to be curled over the pipe 108 to detect defects in the pipe 108. Specifically, the bendable digital detectors may utilize radiation such as x-rays to detect defects in the pipe 108. The defects may include cracks, cavities, corrosion, variation in wall thickness of the pipe 108, incomplete joining or penetration of weld material in the pipe 108, slag trapped within the weld, or the like. In an embodiment, the digital detector 104 may digital radiography technique in which the digital detector 104 may utilize X-rays to capture X-ray images of the pipe 108 and may detect defects upon analyzing the X-ray images. The embodiments of the present disclosure are intended to include or otherwise cover any other known, related, or later developed technology other than digital radiography, without deviating from the scope of the present disclosure.

The control box 106 may be coupled to the bendable digital detector 104 and may be configured to receive one or more X-ray images from the bendable digital detector 104. Specifically, the control box 106 may be coupled to the bendable digital detector 104 by way of the at least one connecting wire 112. In an embodiment of the present disclosure, the control box 106 may facilitate transfer of images wirelessly over long distances to a remote device or monitoring station. Specifically, the control box 106 may be coupled to the bendable digital detector 104 when an evacuation zone is large and high radiation are used. Further, the control box 106 may be decoupled from the bendable digital detector 104 when long range transfer of the one or more X-rays images is not required.

The pipe 108 may be a pipe over which non-destructive testing (NDT) is required to be done. In an embodiment of the present disclosure, the pipe 108 may be a part of pipeline associated with an offshore gas and oil pipeline. In various other embodiments, the pipe 108 may be part of any other pipeline, without deviating from the scope of the present disclosure.

The stand 110 may a stand for providing support to the control box 106 such that the stand 110 may be raised at a predefined height from ground. In an embodiment the stand 110 may include four legs to support the control box 106. In other embodiment the stand 110 may include any number of legs that are required to support the control box 106, without deviating from the scope of the present disclosure.

The at least one connecting wire 112 may be configured to couple the control box 106 to the bendable digital detector 104. In some embodiments the at least one connecting wire 112 may include connecting pins (not shown) at extreme ends of the at least one connecting wire 112. The connecting pins may be configured to be received inside jacks (not shown) disposed on the armor 102 and/or bendable digital detector 104 to communicatively couple the control box 106 to the bendable digital detector 104.

In operation, the bendable digital detector 104 housed inside the armor 102 may be wrapped around the pipe 108 such that the armor 102 may allow the bendable digital detector 104 to be bent in a way such that beyond the predefined degree of bend, bending of the bendable digital detector 104 is locked by way of the constructional features of the armor 102 (explained later). Further, the bendable digital detector 104 may capture x-ray images of the pipe 108 and detect the defects inside the pipe 108. Further, the x-rays images may be transmitted by way of the al least one connecting wire 112 to the control box 106 standing over the stand 110 when long range transfer of the one or more X-rays images are required.

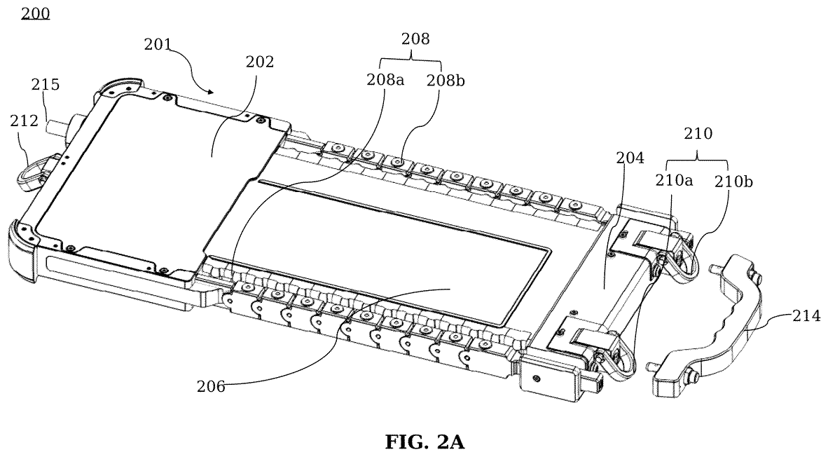

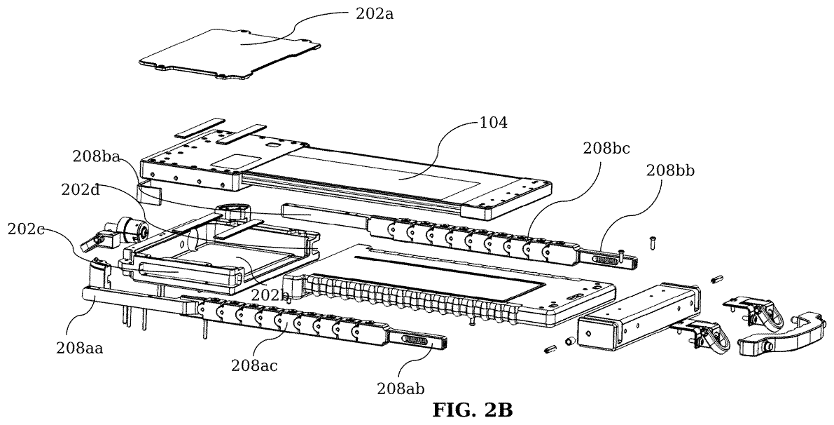

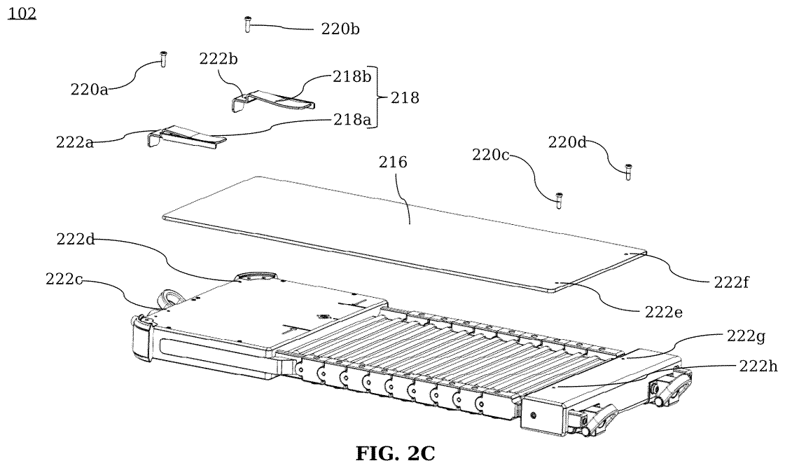

FIG. 2A illustrates an isometric view 200 of the armor 102 housing the bendable digital detector 104 in FIG. 1, according to an exemplary embodiment of the present disclosure. As shown in FIG. 2A, the armor 102 may include a body 201, one or more chain link assembly 208, one or more shackles 210, at least one shackle 212, and a handle 214.

The body 201 may be configured to prevent the bendable detector 104 from damage due to falls, drops, or shocks. The body 201 may include a first portion 202, a second portion 204, and a third portion 206. The third portion 206 may be disposed between the first portion 202 and the second portion 204, creating a flexible connection. In some aspects of the present disclosure, the third portion 206 may be a rubber sleeve made up of one of rubber, polyurethane, polycarbonate, polyether, polyester, or a combination thereof. The flexible nature of the third portion 206 may allow for movement of the armor 102 while maintaining protection of the internal components. The first portion 202 and the second portion 204 of the armor 102 may be configured to receive a top and a bottom portion of the bendable digital detector 104. The first portion 202 and the second portion 204 of the armor 102 may be made of Acrylonitrile Butadiene Styrene (ABS).

The one or more chain link assembly 208 may be coupled to the first portion 202 and the second portion 204. Specifically, the one or more chain link assembly 208 may be coupled to the first and second side ends of the first portion 202 and the second portion 204, respectively. The one or more chain link assembly 208 may be configured to restrict the bending of the body 201 housing the bendable digital detector 104. Specifically, the one or more chain link assembly 208 may be configured to restrict the bending of the body 201 about one side of a latitudinal direction of the chain link assembly 208 beyond a predefined degree of bend while prevent the bending of the body 201 about another side of the latitudinal direction of the chain link assembly 208. The one or more chain link assembly 208 may include a first chain link assembly 208a and a second chain link assembly 208b. The first chain link assembly 208a and the second chain link assembly 208b may be coupled to the first and second side ends of the first portion 202 and the second portion 204, respectively. Specifically, first and second side ends of the chain link assembly 208a may be coupled to the first side end of the first portion 202 and the first side end of the second portion 204, respectively. Similarly, first and second side ends of the chain link assembly 208b may be coupled to the second side end of the first portion 202 and the second side end of the second portion 204, respectively.

The one or more shackles 210 may be coupled to the second portion 204. The one or more shackles 210 may include a first shackle 210a and a second shackle 210b. The at least one shackle 212 may be coupled to the first portion 202. The first shackle 210a and the second shackle 210b may be coupled to the at least one shackle 212 by way of one or more bungee cords, rope, or the like.

The handle 214 may be adapted to be coupled to the second portion 204. In some embodiment, the handle 214 may be detachably coupled to the second portion 204 by way of one or more holes disposed on the second portion 204. In some embodiments of the present disclosure, the handle 214 may include a mechanism for quick coupling and de-coupling of the handle 214 with the second portion 204.

In some embodiments of the present disclosure, the armor 102 may further include at least one aperture 215 disposed on the first portion 202. The at least one aperture 215 may be configured to receive at least one cable connector pin (not shown) of at least one connecting wire 112.

FIG. 2B illustrates an exploded view of top face of the isometric view 200 of the FIG. 2A, according to an exemplary embodiment of the present disclosure. As illustrated in FIG. 2B, the first portion 202 may include a lid portion 202a, a first housing portion 202b, a first blind slot 202c, and a second blind slot 202d. The lid portion 202a may be configured to cover the top portion of the bendable digital detector 104. The first housing portion 202b may be configured to house the top portion of the bendable digital detector 104. The first blind slot 202c and the second blind slots 202d may be disposed at the first and second side ends of the first portion 202.

Further as illustrated in FIG. 2B, the first chain link assembly 208a and the second chain link assembly 208b may include one or more first connector components, one or more chain portion having at least two chain links coupled to each other, and one or more second connector components. In an embodiment, each chain link of the at least two chain links may include one or more semicircular parts disposed at a head end of each chain link and a semicircular part that is disposed at a tail end of each chain link. Further, each of the one or more first connector components may be coupled to a first link of the at least two chain links. Specifically, each of the one or more first connector components may include a semicircular part disposed at a first end that is configured to be coupled to the one or more semicircular parts disposed at the head end of the first link. Similarly, each of the one or more second connector components may be coupled to a last link of the at least two chain links. Specifically, each of the one or more second connector components may include one or more semicircular parts at a first end that is configured to be coupled the semicircular part disposed at the tail end of the last link.

The first chain link assembly 208a may include a first connector component 208aa, a second connector component 208ab, and a chain portion 208ac. The first connect component 208aa may be configured to be coupled to the first blind slot 202c. Similarly, the second chain link assembly 208b may include a first connector component 208ba, a second connector component 208bb, and a chain portion 208bc. The second connector component 208ba may be configured to be coupled to the second blind slot 202d. Thus, the one or more first connector components may include first connector component 208aa and the first connector component 208ba, while the one or more second connector components may include the second connector component 208ab and the second connector component 208bb.

FIG. 2C illustrates an exploded view of rear face of the isometric view 200 of the FIG. 2A, according to an exemplary embodiment of the present disclosure. As illustrated in FIG. 2C, the rear face of the isometric view 200 of the armor 102 housing the bendable digital detector 104 may include a lead shielding sheet 216. The lead shielding sheet 216 may be coupled to the rear portion of the body 201 of the armor 102. Specifically, the lead shielding sheet 216 may be a first flexible clip 218a and a second flexible clip 218b. The first flexible clip 218a and the second flexible clip 218b may include a first hole 222a and a second hole 222b disposed thereon. The rear face of the body 201 may further include third and fourth holes 222c-22d, and seventh and eighth holes 222g-222h disposed thereon. Specifically, the third hole 222c and the fourth hole 222d may be configured to be aligned to the first hole 222a and the second hole 222b. A first pin 220a and a second pin 220b may be configured to pass through the first through fourth hole 222a-222d to couple the top portion of the lead shielding sheet 216 to the rear face of the body 201. Further, the lead shielding sheet 216 may include fifth and sixth holes 222e-222f disposed thereon. The fifth hole 222c and the sixth hole 222f may be configured to be aligned to the seventh and eighth holes 222g-222h such that fourth and fifth pins 220c-220d may pass through the fifth through the eighth hole 222e-222h to couple the lower portion of the lead shielding sheet 216 to the to the rear face of the body 201. The lead shielding sheet 216 may be configured to absorb backscattered radiation during use with high radiation sources.

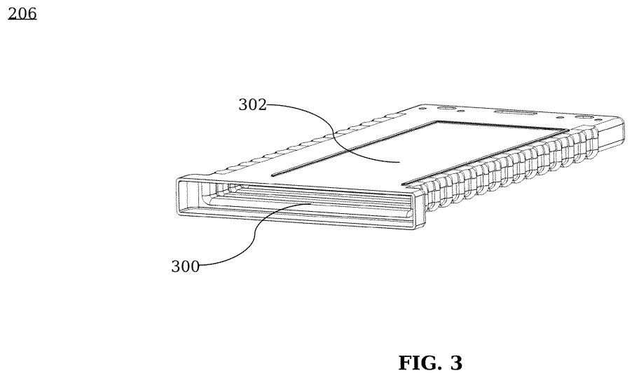

FIG. 3 illustrates an isometric view of a third portion 206 of the armor 102 of FIG. 2A, according to an exemplary embodiment of the present disclosure. As illustrated in FIG. 3, the third portion 206 may include a second housing area 300 and a radiation receiving area 302. The second housing area 300 may be configured to house the middle portion of the bendable digital detector 104. The radiation receiving area 302 may be a recessed area of the third portion 206, creating a dedicated space for detecting radiation.

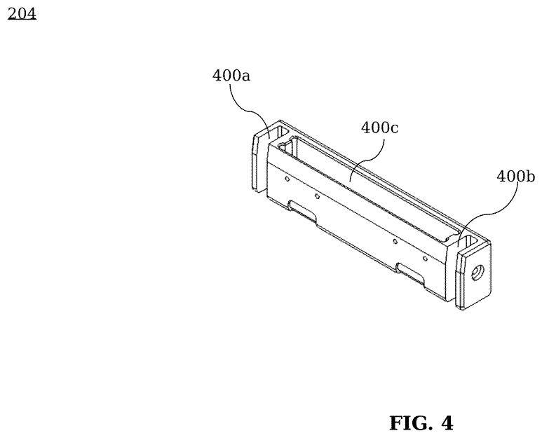

FIG. 4 illustrates an isometric view of a second portion 204 of the armor 102 of FIG. 2A, according to an exemplary embodiment of the present disclosure. As illustrated in FIG. 4, the second portion 204 may include a first and second through slots 400a and 400b disposed at first and second ends of the second portion 204. The first and second through slots 400a and 400b may be configured to be coupled to the second connector component 208ab of the first chain link assembly 208a and the second connector component 208bb of the second chain link assembly 208b, respectively. The second portion 204 may further include a third housing portion 400c. The third housing portion 400c may be configured to house or receive a bottom portion of the bendable digital detector 104.

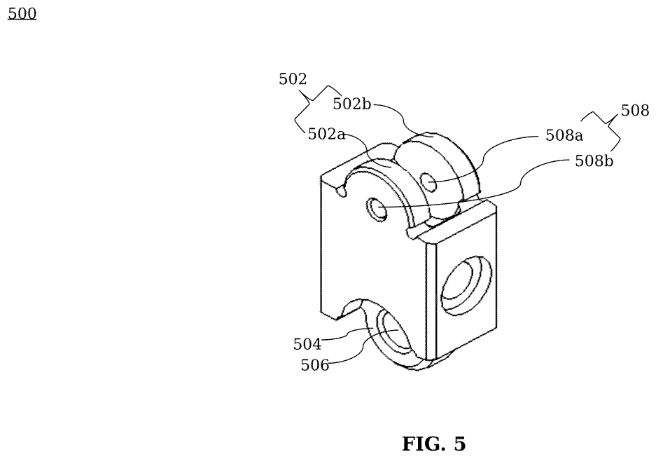

FIG. 5 illustrates a chain link 500 of a chain portion 208ac, 208bc of FIG. 2B, according to an exemplary embodiment of the present disclosure. As illustrated in FIG. 5, the chain link 500 may include one or more semicircular parts 502 disposed at the head end and a semicircular part 504 disposed at the tail end. In an embodiment, the one or more semicircular parts 502 may include one or more through holes 508. The one or more semicircular parts 502a may include a first semicircular part 502a and a second semicircular part 502b. The first semicircular part 502a and the second semicircular part 502b may include a first through hole 508a and a second through hole 508b. The semicircular part 504 disposed at the tail end may include a third through hole 506. The chain link 500 may be coupled to an adjacent chain link in the chain portion 208ac, 208bc by passing a pin through the one or more holes 508 of the chain link 500 and the third through hole 506 of the adjacent chain link, when the one or more holes 508 of the chain link 500 and the third through hole 506 of the adjacent chain link are aligned.

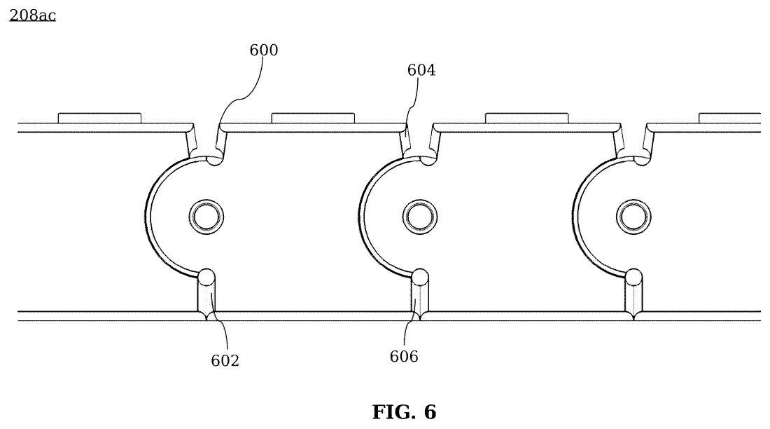

FIG. 6 illustrates coupling of the one or more chain links within the one or more chain link assembly 208 in an unbent position, according to an exemplary embodiment of the present disclosure. More particularly, FIG. 6 illustrates the chain portion 208ac having at least two chain links coupled to each other when the one or more chain link assembly 208 is in an unbent position, according to an exemplary embodiment of the present disclosure. As illustrated in FIG. 6, each chain link of the chain portion 208ac may include a first projection 600 and a second projection 602 projecting from first and second ends of the one or more semicircular parts 502. The first projection 600 may slant at an angle in a direction away from the head end of the one or more semicircular parts 502. The second projection 602 may be at a right angle with respect to a longitudinal axis of the one or more chain link assembly 208. Similarly, each chain link of the chain portion 208ac, 208bc may include a first projection 604 and a second projection 606 projecting from first and second ends of the semicircular parts 504. The first projection 604 may slant at an angle in a direction away from the tail end of the semicircular part 504. The second projection 606 may be at a right angle with respect to the longitudinal axis of the one or more chain link assembly 208.

When the one or more chain link assembly 208 is in an unbent position, the second projection 602 of a chain link may be engaged with the second projection 606 of another chain link in the chain portion 208ac thereby restricting bending of the armor 102. Simultaneously, there is a gap between the first projection 600 of the chain link and the first projection 604 of another chain link. The first projection 600 of the chain link and the first projection 604 of another chain link may be engaged with each other when the armor 102 is bent to the predefined degree thereby providing a controlled bending movement of the armor 102 along with the bendable digital detector 104. In other words, when a bending force is applied to bend the armor 102 in a direction such that the first projection 600 and the first projection 604 may allow bending movement until the first projection 600 and the first projection 604 may come in contact, thereby limiting further bending. Conversely, when the bending force is applied in the opposite direction, the second projection 602 and the second projection 606 may immediately come in contact to prevent any bending motion in the opposite direction.

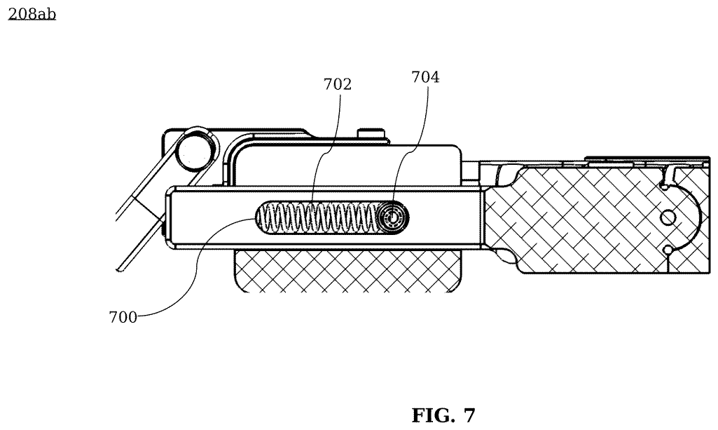

FIG. 7 illustrates a side view of a second connector component 208ab of the one or more second connector components of the one or more chain link assembly 208, according to an exemplary embodiment of the present disclosure. Each of the second connector component 208ab, 208bb may be coupled to the side ends of the second portion 204. Specifically, each of the second connector component 208ab, 208bb may be coupled to the first and second through slots 400a and 400b disposed at the side ends of the second portion 204. Each of the second connector components 208ab, 208bb may include a through slot 700 disposed at a second end of the second connector components 208ab, 208bb, respectively. Further, each of the second connector components 208ab, 208bb may include a spring 702 disposed in the through slot 700. Further at least one pin 704 is configured to pass through each of the one or more through slots 400a, 400b, and the through slot 700 disposed at the second end of each of the one or more second connector components. Further, a first end of the spring 702 is disposed on an inner circumferential region of the through slot 700 and a second end of the spring 702 is disposed on the at least one pin 704.

The through slot 700 may be disposed at a second end of the second connector component 208ab, 208bb while a first end of the second connector component 208ab, 208bb may be coupled to the chain portion 208ac, 208bc. The at least one pin 704 may be configured to pass through the through slots 400a, 400b and the through slot 700 such that a first end of the spring 702 is disposed on the inner circumferential region of the through slot 700 and a second end of the spring 702 is disposed on the at least one pin 704.

The arrangement of the through slot 700, the spring 702, and the at least one pin 704 may allow for adjustment of slack in the one or more chain link assembly 208 when the armor 102 is in bent and unbent positions. Specifically, the connecting pin 704 may move within the through slot 700 in response to bending of the armor 102. The spring 702 may provide a tensioning force on the connecting pin 704, which may help maintain proper tension in each of the one or more chain link assembly 208 as the armor 102 flexes.

In some aspects of the present disclosure, the spring 702 may be a coiled spring. The spring 702 may compress or expand as the at least one pin 704 moves within the through slot 700, providing variable tension to accommodate different degrees of bending in the armor 102.

As the armor 102 bends, the connecting pin 704 may move along the length of the through slot 700, allowing each of the one or more chain link assembly 208 to articulate relative to each other while maintaining a controlled range of motion.

In some aspects of the present disclosure, bearings may be incorporated into each of the one or more chain link assembly 208 to facilitate smooth movement between components. The bearings may include sleeve bearings, journal bearings, sliding bearings, thrust washers, or sleeves. The bearings may reduce friction and wear between moving parts of each of the one or more chain link assembly 208, enhancing durability and performance of the armor 102.

In some cases, a plunger may be used in conjunction with each of the one or more chain link assembly 208 to provide additional control over the movement and positioning of chain links. The plunger may be a ball plunger, spring plunger, press fit spring plunger, double spring plunger, or threaded spring plunger. The plunger may engage with features on adjacent chain links to provide tactile feedback or defined positioning points as the armor 102 flexes.

Thus, the system 100 and the armor 102 may provide several technical advantages: The armor 102 incorporates the one or more chain link assembly 208 that enables controlled bending and flexibility while preventing damage from over-bending. The specialized projections on each chain link 500 of the one or more chain link assembly 208 may allow movement in one direction up to a predefined limit while restricting bending in the opposite direction. The auto-lock feature protects the sensitive internal components of the bendable digital detector 104 from excessive strain. The armor's IP67 rating and water-resistant materials offer robust protection against environmental factors like moisture and dust. The integration of lead shielding sleeve 216 minimizes harmful backscatter radiation during high-energy imaging applications. Finally, the armor's design, including materials, provides impact protection while conforming to curved surfaces, enabling imaging of complex geometries like pipelines. The technical advancements result in a versatile, durable, and safe housing for bendable digital detectors used in challenging industrial environments.

1. An armor for bendable digital detectors, the armor comprising:
a body having first and second portions; and
one or more chain link assembly coupled to the first and second portions, wherein each of the one or more chain link assembly comprising at least two chain links coupled to each other such that each chain link of the at least two chain links has a head end and a tail end, wherein each chain link of the at least two chain links comprising;
one or more semicircular parts disposed at the head end, wherein each semicircular part of the one or more semicircular parts comprising first and second projections projecting from first and second ends, respectively, wherein (i) the first projection slants at an angle in a direction away from the head end and (ii) the second projection is at a right angle with respect to a longitudinal axis of the one or more chain link assembly;
a semicircular part that is disposed at the tail end, and configured to be engaged with the one or more semicircular parts of the head end of an adjacent chain link, wherein the semicircular part disposed at the tail end comprising first and second projections projecting from first and second ends, respectively, wherein (i) the first projection slants at an angle in a direction away from the tail end and (ii) the second projection is at a right angle with respect to the longitudinal axis of the one or more chain link assembly.

2. The armor of claim 1, wherein the first portion comprising first and second blind slots disposed at first and second side ends and the second portion comprising first and second through slots disposed at first and second side ends.

3. The armor of claim 1, wherein the body further comprising a third portion disposed between the first and second portions, wherein the third portion is coupled to the first and second portions at first and second ends of the third portion, respectively, wherein the third portion is flexible and composed of one of rubber, polyurethane, polycarbonate, polyether, polyester, or a combination thereof.

4. The armor of claim 1, wherein each semicircular part of the one or more semicircular parts disposed at the head end and the semicircular part disposed at the tail end are having through holes and wherein each semicircular part of the one or more semicircular parts disposed at the head end is configured to be engaged with the semicircular parts of the tail end of the adjacent chain link by way of a pin.

5. The armor of claim 1, wherein each of the one or more chain link assembly further comprising:
one or more first connector components wherein each of the one or more first connector components is coupled to a first link of the at least two chain links, wherein each of the one or more first connector components comprising a semicircular part disposed at a first end that is configured to be coupled to the one or more semicircular parts disposed at the head end of the first link; and
one or more second connector components wherein each of the one or more second connector components is coupled to a last link of the at least two chain links, wherein each of the one or more second connector components comprising one or more semicircular parts at a first end that is configured to be coupled the semicircular part disposed at the tail end of the last link.

6. The armor of claim 5, wherein the one or more first connector components are further coupled to the first portion by way of the one or more blind slots disposed at one or more side ends of the first portion, respectively and wherein each of the one or more second connector components further comprising a through slot disposed at a second end and a spring disposed in the through slot.

7. The armor of claim 5, wherein the one or more second connector components are further coupled to the second portion by way of one or more through slots disposed at one or more side ends of the second portion, respectively wherein the through slot disposed at the second end of each of the one or more second connector components and the spring is disposed inside each of the one or more through slots, respectively.

8. The armor of claim 7, wherein to couple the one or more second connector components to the second portion, at least one pin is configured to pass through each of the one or more through slots and the through slot disposed at the second end of each of the one or more second connector components such that a first end of the spring is disposed on an inner circumferential region of the through slot and a second end of the spring is disposed on the at least one pin.

9. The armor of claim 1, further comprising a lead shielding sheet disposed on a rear face of the body, wherein the lead shielding sheet is configured to absorb backscattered radiation.

10. The armor of claim 1, further comprising:
one or more shackles coupled to the second portion;
at least one shackle coupled to the first portion; and
at least one aperture disposed on the first portion wherein the at least one aperture is configured to receive at least one cable connector pin of at least one connecting wire.

11. A system comprising:
a bendable digital detector; and
an armor configured to receive the bendable digital detector, the armor comprising:
a body having first and second portions; and
one or more chain link assembly coupled to the first and second portions, wherein each of the one or more chain link assembly comprising at least two chain links coupled to each other such that each chain link of the at least two chain links has a head end and a tail end, wherein each chain link of the at least two chain links comprising;
one or more semicircular parts disposed at the head end, wherein each semicircular part of the one or more semicircular parts comprising first and second projections projecting from first and second ends, respectively, wherein (i) the first projection slants at an angle in a direction away from the head end and (ii) the second projection is at a right angle with respect to a longitudinal axis of the one or more chain link assembly;
a semicircular part that is disposed at the tail end, and configured to be engaged with the one or more semicircular parts of the head end of an adjacent chain link, wherein the semicircular part disposed at the tail end comprising first and second projections projecting from first and second ends, respectively, wherein (i) the first projection slants at an angle in a direction away from the tail end and (ii) the second projection is at a right angle with respect to the longitudinal axis of the one or more chain link assembly.

12. The system of claim 11, further comprising a control box that is coupled to the bendable digital detector and configured to receive one or more X-ray images from the bendable digital detector.

13. The system of claim 11, wherein the first portion comprising first and second blind slots disposed at first and second side ends; and the second portion comprising first and second through slots disposed at first and second side ends.

14. The system of claim 11, wherein the body further comprising a third portion disposed between the first and second portions, wherein the third portion is coupled to the first and second portions at first and second ends of the third portion, respectively, wherein the third portion is flexible and composed of one of rubber, polyurethane, polycarbonate, polyether, polyester, or a combination thereof.

15. The system of claim 11, wherein each semicircular part of the one or more semicircular parts disposed at the head end and the semicircular part disposed at the tail end are having through holes, wherein each semicircular part of the one or more semicircular parts disposed at the head end is configured to be engaged with the semicircular parts of the tail end of the adjacent chain link by way of a pin.

16. The system of claim 11, wherein each of the one or more chain link assembly further comprising:
one or more first connector components wherein each of the one or more first connector components is coupled to a first link of the at least two chain links, wherein each of the one or more first connector components comprising a semicircular part disposed at a first end that is configured to be coupled to the one or more semicircular parts disposed at the head end of the first link; and
one or more second connector components wherein each of the one or more second connector components is coupled to a last link of the at least two chain links, wherein each of the one or more second connector components comprising one or more semicircular parts at a first end that is configured to be coupled the semicircular part disposed at the tail end of the last link.

17. The system of claim 16, wherein the one or more first connector components are further coupled to the first portion by way of the one or more blind slots disposed at one or more side ends of the first portion, respectively, wherein each of the one or more second connector components further comprising a through slot disposed at a second end and a spring disposed in the through slot.

18. The system of claim 16, wherein the one or more second connector components are further coupled to the second portion by way of one or more through slots disposed at one or more side ends of the second portion, respectively wherein the through slot disposed at the second end of each of the one or more second connector components and the spring is disposed inside each of the one or more through slots, respectively.

19. The system of claim 18, wherein to couple the one or more second connector components to the second portion, at least one pin is configured to pass through each of the one or more through slots and the through slot disposed at the second end of each of the one or more second connector components such that a first end of the spring is disposed on an inner circumferential region of the through slot and a second end of the spring is disposed on the at least one pin.

20. The system of claim 11, wherein the armor further comprising:
a lead shielding sheet disposed on a rear face of the body, wherein the lead shielding sheet is configured to absorb backscattered radiation;
one or more shackles coupled to the second portion;
at least one shackle coupled to the first portion; and
at least one aperture disposed on the first portion wherein the at least one aperture is configured to receive at least one cable connector pin of at least one connecting wire that is configured to couple the bendable digital detector to the control box.
